(19) United States
(12) Patent Application Publication
(10) Pub. No.: US 2005/0229765 A1
(43) Pub. Date: Oct. 20, 2005

(54) Information flow out preventing punch

(76) Inventor: Mika Watanabe, Saitama (JP)

Correspondence Address: MCGINN & GIBB, PLLC, 8321 OLD COURTHOUSE ROAD, SUITE 200, VIENNA, VA, 22182-3817, US

(21) Appl. No.: 10/518,459

(22) PCT Filed: Jun. 25, 2003
(86) PCT No.: PCT/JP03/08034

§ 371 Date: Dec. 22, 2004

(30) Foreign Application Priority Data
Jun. 25, 2002 (JP) 2002-185314

(51) Int. Cl. B26D 1/12

(52) U.S. Cl. 83/669

(57) ABSTRACT

An information flow out preventing punch for easily punching a hole in an address portion and a magnetic recording portion of a direct mail so that a third person cannot read those portions. The punch is small in size and light in weight and can be put into a drawer of a desk. The punch can punch not only paper but also a plastic card. Resources such as postcards after punched can easily be collected. This information flow out preventing punch includes an operation section and a punch blade group consisting of two or more punch blades. The punch blade group is moved by the operation section so as to punch a plurality of holes in a punch object. In the punch blade group, adjacent punch blades of n-th blade and n+1-th blade are in such a proximity that understanding of the information presented on the punch object becomes difficult.

### TECHNICAL FIELD

The present invention relates to a punch for punching a plurality of holes in a sheet of paper, which is a punch material, to make it difficult to identify information, such as characters, in order to prevent the outflow of information written thereon, and more particularly to an information outflow prevention punch advantageously used for cutting out addresses that are personal information written on direct mail such as postcards or envelopes.

### BACKGROUND ART

Direct mail we receive almost every day has most basic personal information, such as an address and a name, written thereon unprotected. We sometimes throw away such direct mail without disposing of personal information. However, as we often hear about stalkers on the news today, we peel address stickers or tear up postcards or envelopes in many cases before throwing them away to make addresses unreadable for preventing personal information from being spread from an unknown source.

We hesitate to unguardedly throw away not only direct mail but also other materials such as a bank slip, a personal memo, an expired credit card, a membership card, and other cards. Especially, a recent trend in privacy protection has rapidly increased the need for preventing the outflow of personal character information or magnetically recorded information.

However, it is very difficult to properly peel or tear off the part of an address written on direct mail so that it cannot be identified. That is, because an address sticker is not peeled off or torn as intend, we must repeat the work many times until the address or name part cannot be identified. To solve this problem, a personal-type shredder is now in practical use to reduce the effort required for tearing up direct mail.

On the other hand, even a personal type shredder is large, takes up space, and is difficult to carry. Therefore, it is not a tool for an individual to use easily. Another problem with a shredder is that a plastic card cannot be disposed of but must be cut with scissors. In addition, although most postcards and non-window envelopes can be collected for recycling, shredded paper produced in the home cannot practically be collected for recycling and therefore cannot be collected as with torn paper.

### DISCLOSURE OF THE INVENTION

In view of the foregoing, it is an object of the present invention to provide an information outflow prevention punch that allows a user to easily punch holes in the address part or magnetically recorded part of direct mail to prevent a third party from reading the information, that is small and light enough to be stored in the drawer of a desk, that can punch holes not only in sheets of paper but in a plastic card, and that produces punched postcards that can be collected easily for recycling.

To solve the problems described above, the content of the present invention relates to an information outflow prevention punch comprising an operation part that is longitudinally long; a punch blade group composed of two or more punch blades forming a column in a longitudinal direction in the operation part; a rotation axis running at a right angle to a direction of the column of the punch blades and provided in a front end side of the operation part; a top base supporting the rotation axis in the front end side; and a bottom base fixed to the top base in a rear end side and forming an insertion slot for a punch material in conjunction with the top base, characterized in that the operation part rotates up and down with the rotation axis as a fulcrum, in that neighboring n-th punch blade and (n+1)-th punch blade of the punch blade group are provided close to such a degree that information written on the punch material cannot be identified, and in that a punch material is inserted from the insertion slot at the front edge side of the operation part and the rear end of the operation part is pushed down to lower the punch blade group from above the top base to punch a plurality of holes in the punch material for preventing information outflow.

To make it difficult to identify information written on the punch material, the diameter of each punch blade of the punch blade group is preferably φ3 mm to φ20 mm and that the spacing between the neighboring n-th punch blade and (n+1)-th punch blade of the punch blade group is preferably smaller than the diameter of the n-th and (n+1)-th punch blades.

To allow a punch material to be easily inserted under the punch blades, the information outflow prevention punch preferably has a lifting spring for the operation part and the punch blade group and, in particular, the blade edges of the punch blades of the punch blade group are preferably lowered parallel to the surface of a punch material. In addition, to make the punching work easier, a marking indicating the position of the punch blade group is preferably provided.

The information outflow prevention punch preferably has a chip bin under the punch blade group to dispose of punch chips and, from the viewpoint of storage when the punch is not used, preferably has a stopper that keeps the operation part in the pushed-state.

### BRIEF DESCRIPTION OF THE DRAWINGS

FIG. 1 is a perspective view of an information outflow prevention punch in a first embodiment according to the present invention.

FIG. 2 is a top view, a side view, and a cross section diagram of the information outflow prevention punch in the first embodiment.

FIG. 3 is a part drawing of an operation part, a stopper, and a top base in the first embodiment.

FIG. 4 is a part drawing of a bottom base and a chip bin in the first embodiment.

FIG. 5 is a part drawing of a punch blade group and a lifting spring in the first embodiment.

FIG. 6 is a conceptual diagram showing the investigation of how the first embodiment is actually used.

FIG. 7 shows the result of classification of postcards and envelopes into FIG. 6(A)-(D) and so on.

FIG. 8 is a cross section diagram showing an information outflow prevention punch in a second embodiment according to the present invention.

FIG. 9 is a cross section diagram showing an information outflow prevention punch in a third embodiment according to the present invention.

FIG. 10 is a cross section diagram showing an information outflow prevention punch in a fourth embodiment according to the present invention.

FIG. 11 is a cross section diagram showing an information outflow prevention punch in a fifth embodiment according to the present invention.

FIG. 12 is a cross section diagram showing an information outflow prevention punch in a sixth embodiment according to the present invention.

### BEST MODE FOR CARRYING OUT THE INVENTION

An information outflow prevention punch according to the present invention punches a plurality of holes in punch materials to prevent information outflow. Punch materials here include not only direct mail such as a postcard and an envelope, bank slips, personal memo, expired credit cards, membership cards, and other cards but also all paper and plastic materials whose information the user wants to protect against outflow and which can be punched.

Punch parts typically include a character part indicating personal information such as an address, a name, a place of employment, and a hobby, a numeric part indicating information such as a telephone number, a credit number, and an account number, a photograph part containing a photograph on a certificate, and a magnetically recorded part on a magnetic card. In addition to those parts, the punch part includes any part whose information the user wants to protect against outflow and which can be punched.

To prevent information outflow, the information outflow prevention punch according to the present invention comprises an operation part that is longitudinally long and a punch blade group composed of two or more punch blades that form a column in a longitudinal direction in the operation part. That is, the operation part is used for moving the punch blade group to punch holes to make it difficult to identify information, and the two or more punch blades are provided to punch a plurality of holes at a time. Any mechanism of moving punch blades may be used; however, to reduce the size, the operation part is longitudinally long and the punch blades form a column in the longitudinal direction within the operation part to allow the operation part to rotate up and down with the rotation axis, running at a right angle to the direction of column of punch blades, as the fulcrum and to allow the user to simply punch holes with the punch in his or her hand. When a punch material is inserted into the insertion slot in the front-end side of the operation part and the rear end of the operation part is pushed down, the punch blade group is lowered from above the top base. The punch blade group may be composed of a plurality of punch blades that are separate but interlocked or may be a group of integrated punch blades formed by machining.

More punch blades increase the efficiency but make the punch larger. Thus, depending upon the size of a punch blade, five to nine punch blades that can punch a name and an address at a time are preferable.

On the other hand, though the optimum punch blade size varies with characters and numerals in a punch part, it is preferable that the actual diameter of a punch blade of the punch blade group be φ3 mm to φ20 mm. A punch blade with a diameter smaller than φ3 mm could punch only a part of most characters, about 10 points in size, and the punched characters are left identifiable; a punch blade with a diameter larger than φ20 mm would make the punch so large that a storage or portability problem is generated. Although the cross sectional shape of a punch blade may be a square or some other shape, a circle is preferable from the viewpoint of productivity and the most preferable diameter is φ5 mm to φ8 mm considering the size of characters included in direct mail.

To prevent information outflow, in the information outflow prevention punch of the present invention, the neighboring n-th punch blade and (n+1)-th punch blade of the punch blade group, provided for punching holes must be close to such a degree that the information written on a punch material cannot be identified. The optimum closeness degree varies according to the size of characters, character spacing, and line spacing in a punch part. More specifically, the spacing between the neighboring punch blades of the punch blade group is preferably smaller than the diameter of the n-th punch blade and smaller than the diameter of the (n+1)-th punch blade. That is, when the diameters of the neighboring punch blades are different, the diameter of the spacing should be smaller than the smaller diameter of the neighboring punch blades to make the information unidentifiable in its entirety.

For example, if the number of characters included in the character information left un-punched between the punch blades is approximately less than two characters or, in particular, less than one half of a character, it becomes difficult to identify the information in its entirety. Considering the size of a character written on direct mail or its character spacing, the spacing of 0.5 mm to 2 mm is particularly preferable in terms of numerical values.

As described above, a shredder has been used conventionally as a tool to protect security. It should be noted that the structure of the information outflow prevention punch of the present invention is completely different from that of a shredder in that the shredder is a machine that shreds the whole of an unnecessary document into strips while the information outflow prevention punch of the present invention is a machine that punches holes only in a part to be security protected. Because a shredder usually shreds paper into strips, there is a danger that information can be read depending upon the character size and the shredding direction. By contrast, because the information outflow prevention punch of the present invention punches holes in a sheet of paper and produces paper pieces each containing one or two characters, there is little danger that the original information is read from those paper pieces.

Conventionally, a punch has been used as a tool for punching filing holes for saving documents. This punch is similar to the information outflow prevention punch according to the present invention in that it comprises an operation part and a punch blade group composed of two or more punch blades, in that the operation part is used to move the punch blade group, and in that it punches a plurality of holes in a punch material.

However, the information outflow prevention punch according to the present invention and the conventional punch for punching filing holes are completely different. That is, the information outflow prevention punch according to the present invention requires that the neighboring n-th punch blade and (n+1)-th punch blade of the punch blade group be close to such a degree that it becomes difficult to identify information written on a punch material. By contrast, the punch for punching filing holes simply punches standard-pitch holes with no consideration for preventing information outflow through punching. Therefore, the neighboring punch blades are spaced at relatively long intervals suitable for filing documents but are not close at all to such a degree that it is difficult to identify information.

Next, the more actual structure of the information outflow prevention punch of the present invention will be described. From the viewpoint of operability, it is preferable that a lifting spring be provided for the operation part and the punch blade group. That is, the lifting spring lifts the punch blade group to allow a punch material to be easily placed under the punch blades at punch time and keeps the operation part in the up position so that, after the operation part is pushed down to lower the punch blade group, the operation part is automatically returned to the original up position.

The blade edges of the punch blades of the punch blade group are preferably lowered parallel to the surface of a punch material. This is because the punch blade edges, if tilted, come into contact with a punch material to be inserted under the punch blades and prevents it from being fully inserted. The information outflow prevention punch according to the present invention, which has many punch blades, has sometimes this problem. If a punch material is caught by any one of punch blades, the operability is significantly affected and the punch material is punched with the punch blades largely tilted with the possibility that the holes cannot be punched properly. It is relatively important to keep the blade edges in parallel to a punch material.

In addition, from the viewpoint of operability, a marking is preferably indicated to show the position of the punch blade group. That is, though the punch blade group should be hidden inside for safety, there is no way for the user to determine whether the characters to be punched are under the punch blade group if the punch blade group is hidden. In particular, it is important to confirm the position of the punch blade group because there is no meaning if the information outflow prevention punch according to the present invention does not punch the character part. Therefore, the marking is indicated to allow the user to know the position of the punch blade group externally from the punch to make the punching work easy. The marking may be indicated for each punch blade or for the whole range of the punch blade group. The marking may also be indicated by the cover of the punch blade group or indicated by a concavity and a convexity or a color coding on the surface.

After the character part is positioned under the punch blade group, the operation part is pushed down to lower the punch blade group for punching. When the operation part is pushed down, the whole operation part is not directly lowered parallel to the surface of a punch material but is rotated up and down around the fulcrum so that the user can apply force easily by hand. That is, because there is a rotation axis, which runs at a right angle to the direction of the column of punch blades and which is in the front-end side of the operation part, and a top base that supports the rotation axis in the front end side, the operation part is rotated up and down with the rotation axis as the fulcrum. Therefore, when a punch material is inserted into the insertion slot of the operation part and the rear end of the operation part is pushed down, holes are punched.

After punching, punch chips are produced, of course, as wastes and, so, it is preferable to provide a chip bin under the punch blade group for disposing of them. From the viewpoint of storage, it is undesirable for the operation part to be operated unintentionally when the punch is not used after punching or for the operation part to be kept automatically in the up position through the lifting spring. To prevent this, it is preferable to provide a stopper that keeps the operation part in the pushed-state.

### EXAMPLES

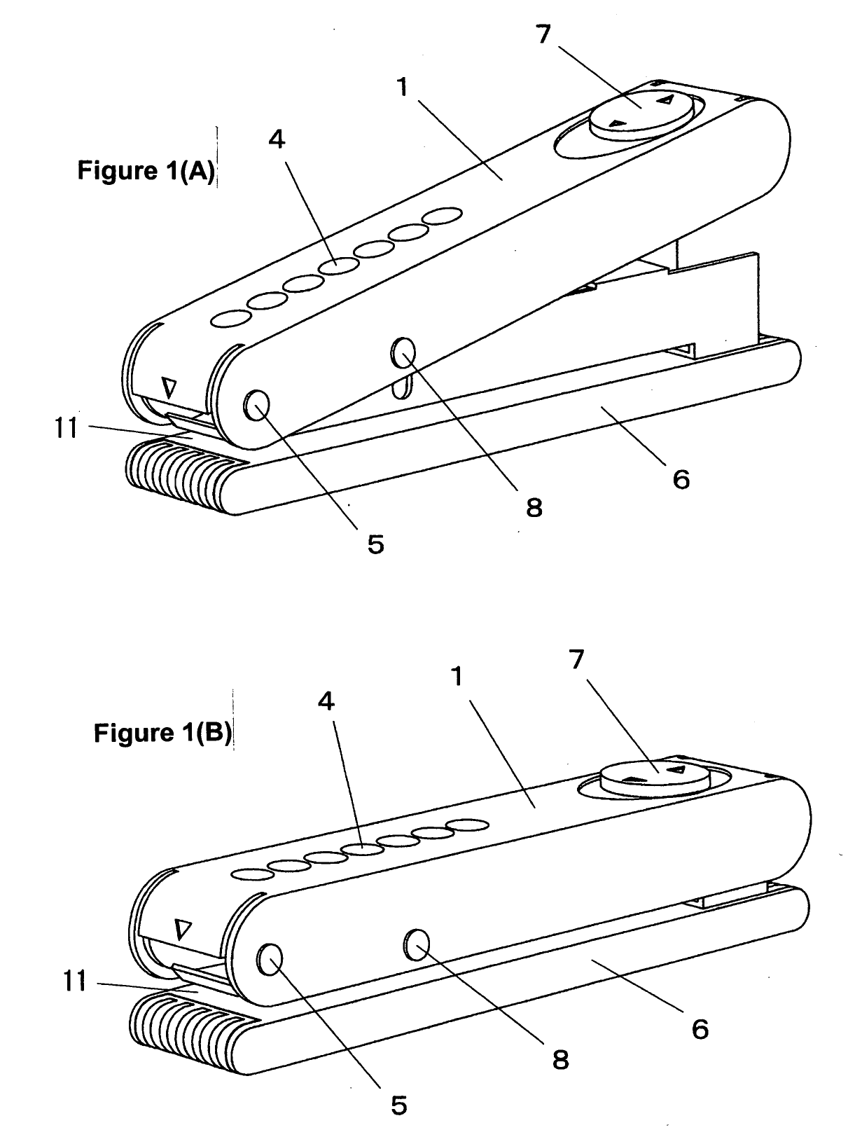

Preferred embodiments of the present invention will be described below with reference to the drawings. FIG. 1 through FIG. 5 are diagrams showing a first embodiment of an information outflow prevention punch according to the present invention. As shown in FIG. 1, the first embodiment is a stapler type punch in which a group of punch blades, mounted inside an operation part 1 by a support axis 8, forms a column in the longitudinal direction of the operation part 1. When the operation part 1 is rotated up and down around a rotation axis 5, which runs at a right angle to the column of punch blades and which acts as the fulcrum, and its position is changed from the one shown in FIG. 1(A) to the one shown in FIG. 1(B) by pushing down the operation part 1, the punch blades are lowered via the support axis 8 to punch a plurality of holes in a punch material.

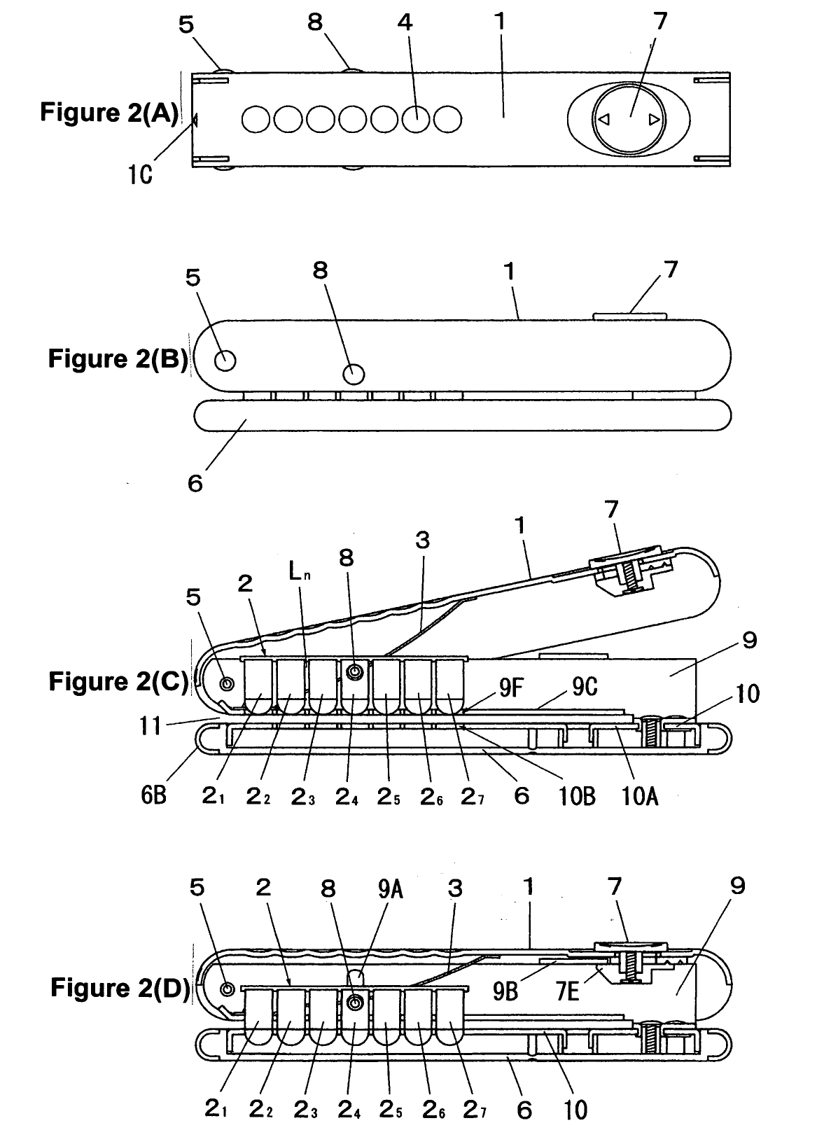

That is, as shown in FIG. 2, the first embodiment comprises the operation part 1, a punch blade group 2 composed of a total of seven punch blades 2₁, 2₂, . . . , 2₇, a lifting spring 3 of the operation part 1 and the punch blade group 2, the rotation axis 5 running at a right angle to the direction of the column of punch blade group 2, a chip bin 6, and a stopper 7 on the operation part 1. The operation part 1 is rotated up and down around the rotation axis 5 at the front edge (left end in FIG. 2) with the rotation axis 5 as the fulcrum. The punch blade group 2, rotatably mounted on the operation part 1 by the support axis 8, moves up and down vertically along a guide slot 9A of a top base 9 as the operation part 1 moves up and down. The chip bin 6 is provided along with the bottom base 10 that is fixed to the top base 9 at the rear end (right end in FIG. 2).

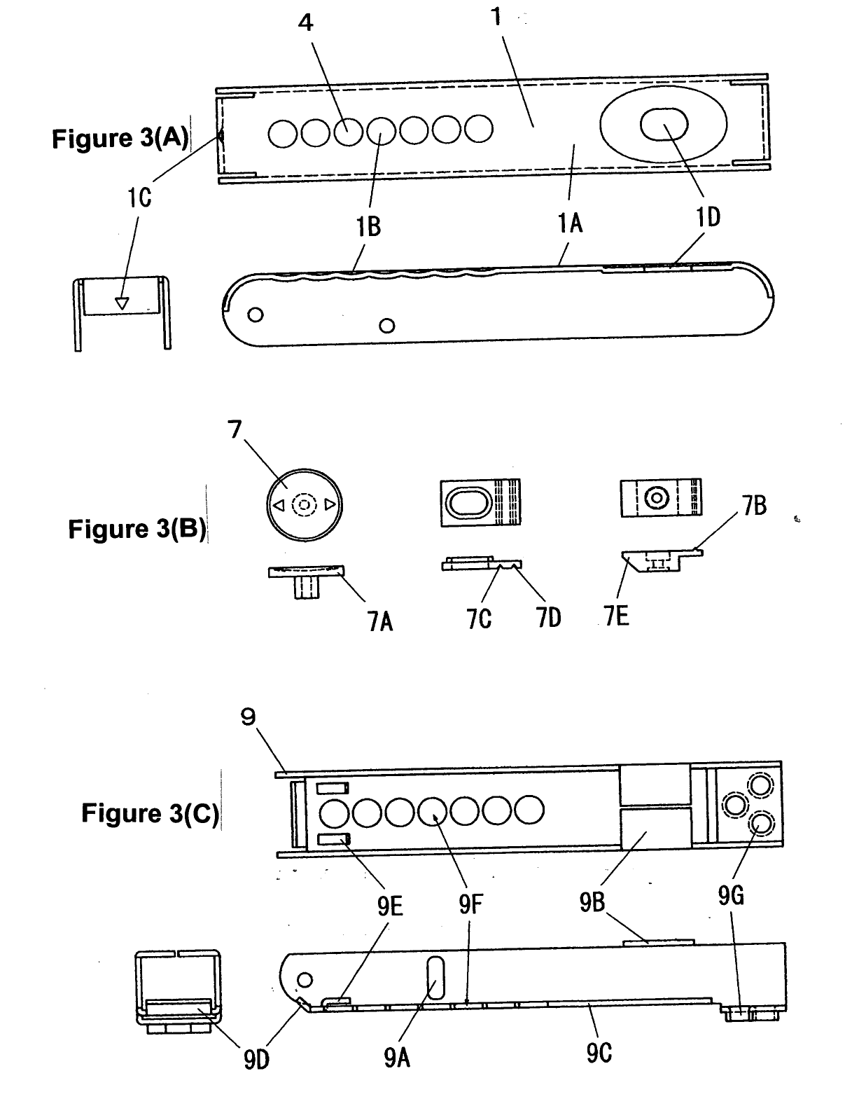

As shown in the part drawing in FIG. 3(A), the operation part 1, made of steel 1.2 mm in thickness t, is 118 mm in length, 21.2 mm in width, and 16 mm in height, and a top plate 1A has concaves 1B, corresponding to the punch blade group, which serve as a marking 4 indicating the positions of the punch blade group. The operation part 1 has a triangle mark 1C at its front edge to indicate the center position of the width of the punch blade group, and has a mounting hole 1D of the stopper 7, shown in FIG. 3(B), at its rear end.

This stopper 7, made of hard urethane rubber, is structured such that an operation plate 7A, φ16 mm in diameter, moves back and forth on the top plate 1A of the operation part 1. At this time, a convex part 7B, which moves with the operation plate 7A, engages a concave part 7C or 7D, fixed on the top plate 1A, to determine the longitudinal position. Note that, when the convex part 7B engages the concave part 7C, a stopping part 7E gets stuck on a top plate 9B of the top base 9 shown in FIG. 3(C).

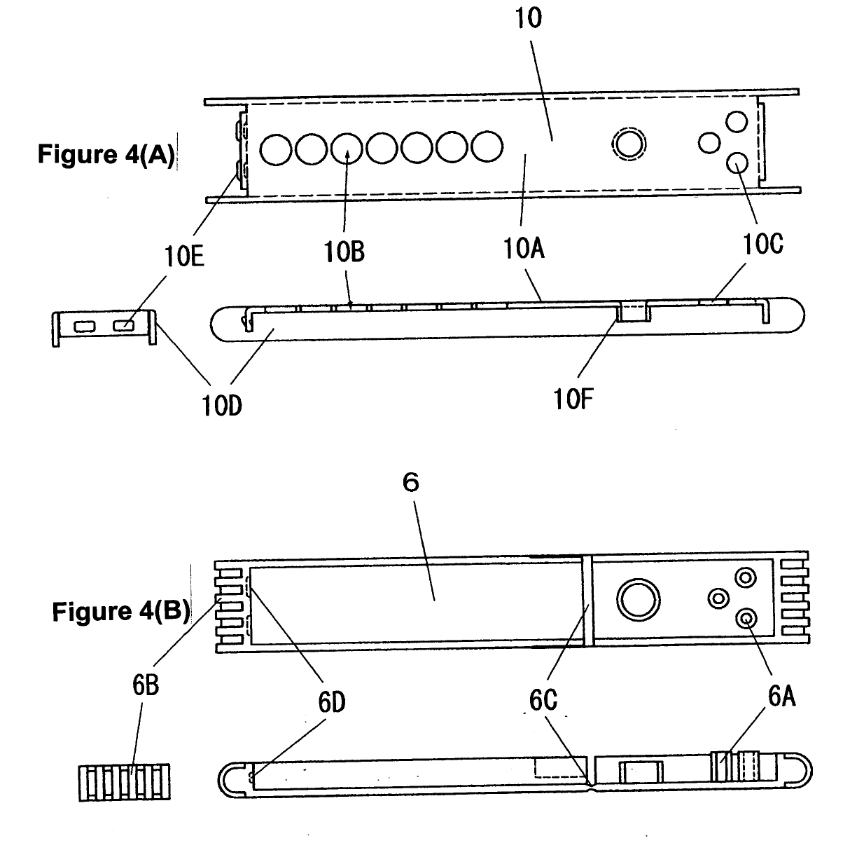

On the other hand, a bottom plate 9C of the top base 9, which serves as an insertion slot for accepting a punch material, has an up-curved guide plate 9D at its front end considering the ease of insertion. The top base 9, also made of steel of 1.2 mm in thickness, is 108.3 mm in length, 18.8 mm in width, and 13.9 mm in height from the bottom plate 9C to the top plate 9B. Also provided in the top base 9 are fixing parts 9E of the lifting spring, guide holes 9F through which the punch blades move, and mounting holes 9G of the bottom base 10 shown in FIG. 4(A) and the chip bin 6 shown in FIG. 4(B).

The bottom base 10 shown in FIG. 4(A), made of steel, is 1.2 mm in thickness t, 118 mm in maximum length, 21.2 mm in width, and 7 mm in height, and its top plate 10A combined with the bottom plate 9C of the top base 9 forms the insertion slot for accepting a punch material. As in the top base 9, guide holes 10B through which the punch blades move are provided. Also included in the bottom base 10 are mounting holes 10C of the chip bin 6 shown in FIG. 4(B), side covers 10D into which the chip bin 6 fit, convex parts 10E that act as the stopper of the chip bin 6, and a convex part 10F that prevents the chip bin 6 from wobbling.

The chip bin 6, made of hard urethane rubber, is 1.5 mm in sidewall thickness t, 118 mm in length, 18.7 mm in width, and 7 mm in height. The rear end side of the chip bin 6 is fixed on the bottom base 10 with mounting holes 6A, while the front end side which has a finger grip 6B opens downward at a bending part 6C. The finger grip 6B has concave parts 6D on its reverse side so that they engage the convex parts 10E on the bottom base 10.

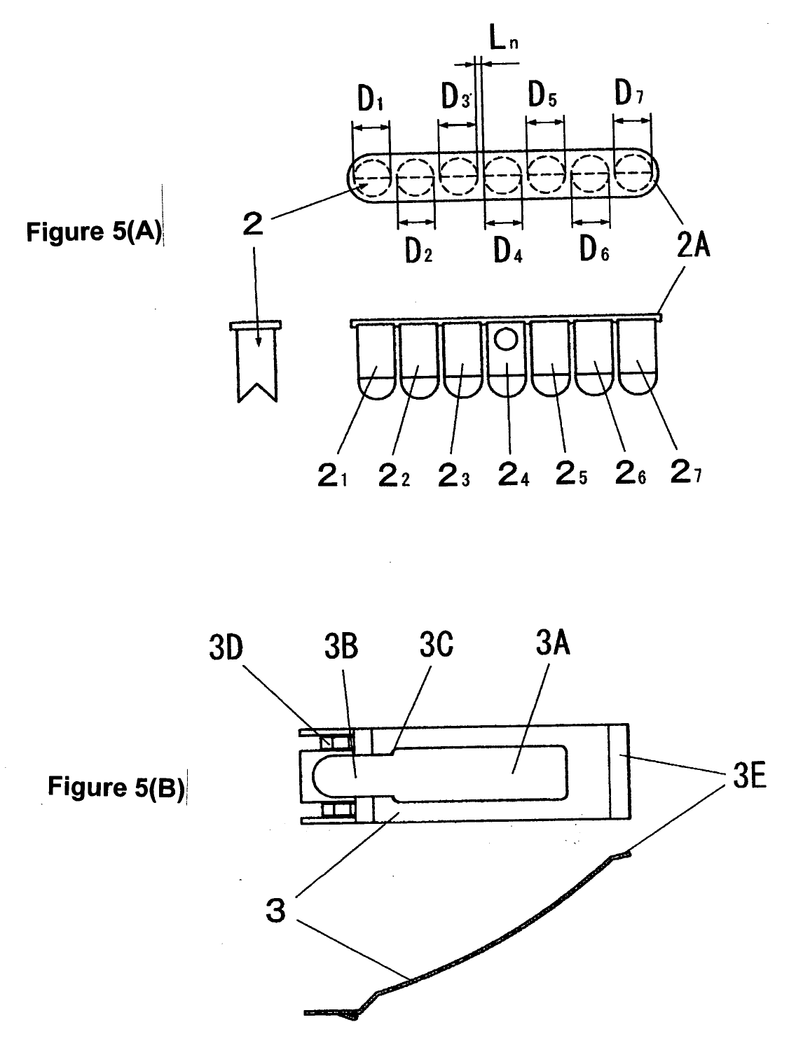

FIG. 5 is a part drawing showing the punch blade group 2 and the lifting spring 3. As shown in FIG. 5(A), the seven steel punch blades 2₁, 2₂, . . . , 2₇ forming the punch blade group 2 all have the same cylindrical shape, and each of diameters D₁, D₂, . . . , D₇ is φ6 mm. The clearance Lₙ between each neighboring punch blade 2, and punch blade 2ₙ₊₁ is 1 mm. The punch blades, 2₁, 2₂, . . . , 2₇, fixed in the oval punch blade base 2A that is 1.2 mm in thickness t, 8 mm in width, and 50 mm in length, are 13.3 mm in height from the blade edge.

This punch blade group 2 is lifted by the lifting spring 3 shown in FIG. 5(B). That is, the lifting spring 3 has a large aperture 3A and a small aperture 3B, and the width of the punch blade base 2A is smaller than that of the large aperture 3A. Therefore, when the punch blade base 2A is inserted into the large aperture 3A and the mounting parts 3D of the lifting spring 3 are inserted into the fixing parts 9E of the top base 9, the lifting spring 3 rises obliquely and the operation part 1 is lifted by a rising end 3E of the lifting spring 3 as shown in FIG. 2(C). Then, the punch blade group 2, interlocked with the operation part 1 via the support axis 8, is also lifted.

Next, with reference to FIG. 2, the usage of the information outflow prevention punch in the first embodiment will be described. In the initial state shown in the cross section diagram in FIG. 2(C), the rear end of the operation part 1 is lifted by the lifting spring 3 into the swing-up position with the rotation axis 5 as the fulcrum and the punch blade group 2 is lifted in the up position also by the lifting spring 3. In this case, because there are the support axis 8, which moves up and down along the guide slot 9A of the top base 9, and the guide holes 9F of the top base 9, the blade edges of the punch blade group 2 are lifted parallel to the bottom plate 9C with the result that the blade edges of the punch blade group 2 are positioned above the bottom plate 9C of the top base 9. As a result, an insertion slot 11, having 2 mm in clearance and clear of any obstacles, is created between the bottom plate 9C of the top base 9 and the top plate 10A of the bottom base 10.

Then, a punch material such as a direct mail postcard is inserted into the insertion slot 11. In this case, the position of the postcard is adjusted based on the marking 4 on the top of the operation part 1 shown in FIG. 2(A) so that the address and name part of the address sticker to be punched is brought right below the punch blade group 2. In addition, the vertical center position of the characters is adjusted based on the triangle mark 1C at the front edge of the operation part 1.

When the user pushes down the rear edge of the operation part 1 in this state, the support axis 8 installed on the operation part 1 is lowered. Then, as the operation part 1 is rotated down, the punch blade group 2, rotatably installed on the operation part 1 via the support axis 8, move up and down along the guide slot 9A of the top base 9. At this time, the blade edges of the punch blade group 2 are vertically lowered parallel to the surface of the postcard through the guide holes 9F of the top base 9. Upon reaching the guide holes 10B of the bottom base 10, the punch blade group 2 punches seven holes in the address and name part of the address sticker and the punch enters the punch end state shown in FIG. 2(B) and FIG. 2(D).

Finally, when the user stops pushing down the operation part 1, the operation part 1 and the punch blade group 2 are returned to the up position again by the lifting spring 3 and the punch is returned to the initial state shown in FIG. 2(C). The punch blades 2₁, 2₂, . . . , 2₇ of the punch blade group 2 each have a diameter (φ6 mm) large enough to punch usual large characters printed on an address sticker. In addition, because the diameter of the clearance Lₙ (1 mm) between punch blade 2ₙ and punch blade 2ₙ₊₁ is also extremely small, a character, if left un-punched in the clearance part, could not be identified. This makes it difficult to identify the address and the name on a punched post card removed from the punch, thus preventing the outflow of personal information. In case the address and the name are longer than the length of the punch blade group 2 or the position is improperly aligned, the same punch operation should be repeated.

Because punched paper chips produced as described above are stored in the chip bin 6, they can be easily disposed of by opening the front end of the chip bin 6 with the use of the finger grip 6B. A postcard, which has a hole but retains its original form, can be put in a special envelop for recycling. In addition, when the user wants to store the punch after use, the user pushes down the rear end of the operation part 1 by hand and moves the stopper 7 into the front-end direction to hook the stopping part 7E onto the top plate 9B of the top base 9. In this way, the punch can be compactly stored near at hand.

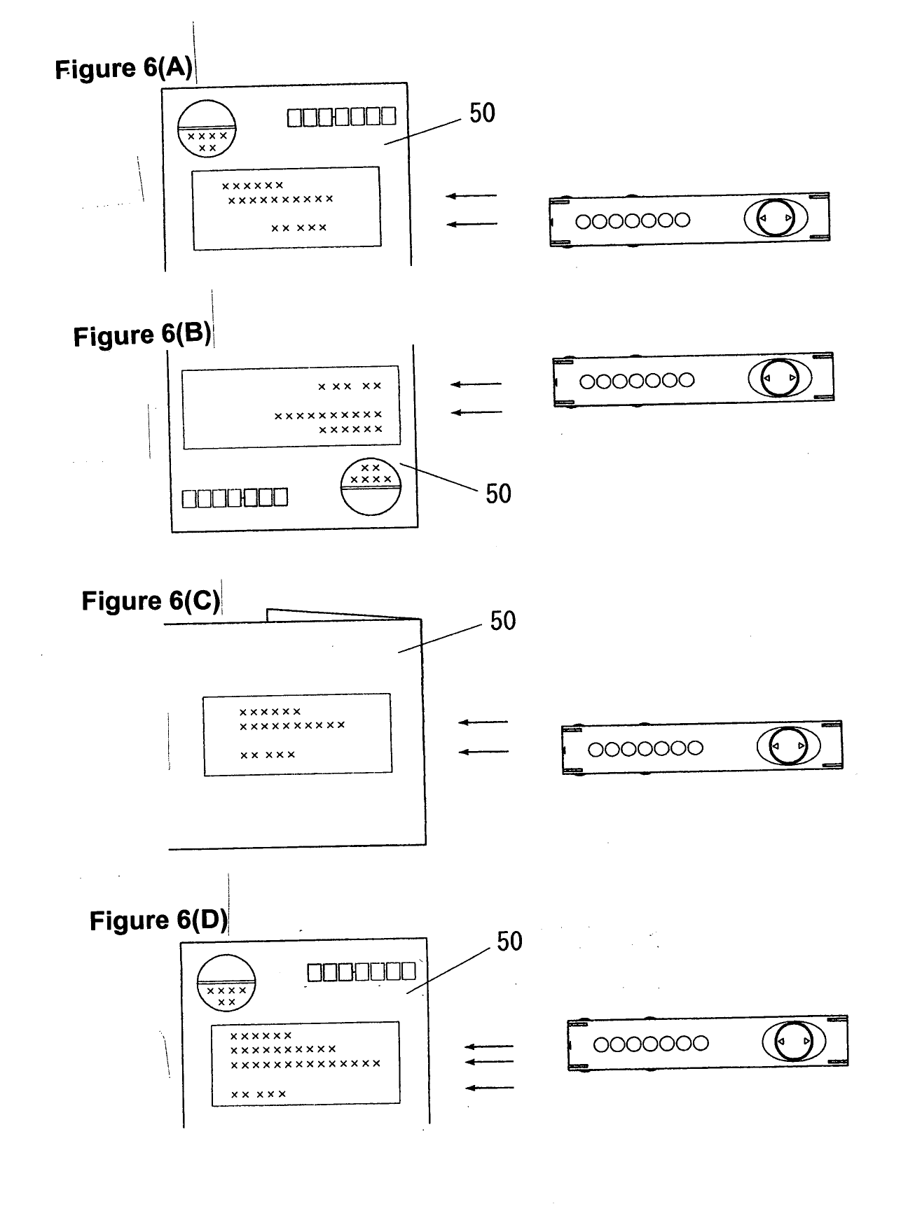

FIG. 6 is a conceptual diagram showing the investigation of how the information outflow prevention punch in the first embodiment is actually used. That is, the figure shows the cases in which 80 postcards and envelopes, which are actually sent as non-private mail such as direct mail and bills, are punch materials 50 and in which the information outflow prevention punch in the first embodiment is used to punch the address and name (indicated by x symbols) parts written on the address stickers.

FIG. 6(A) shows a postcard punched to such a degree that the information cannot be identified by inserting the information outflow prevention punch into the arrow direction and performing the operation twice. FIG. 6(B) shows an upside-down postcard punched to such a degree that the information cannot be identified in two operations. FIG. 6(C) shows an envelope folded into two and punched in two operations to such a degree that the information cannot be identified. FIG. 6(D) shows a postcard punched in three operations to such a degree that the information cannot be identified.

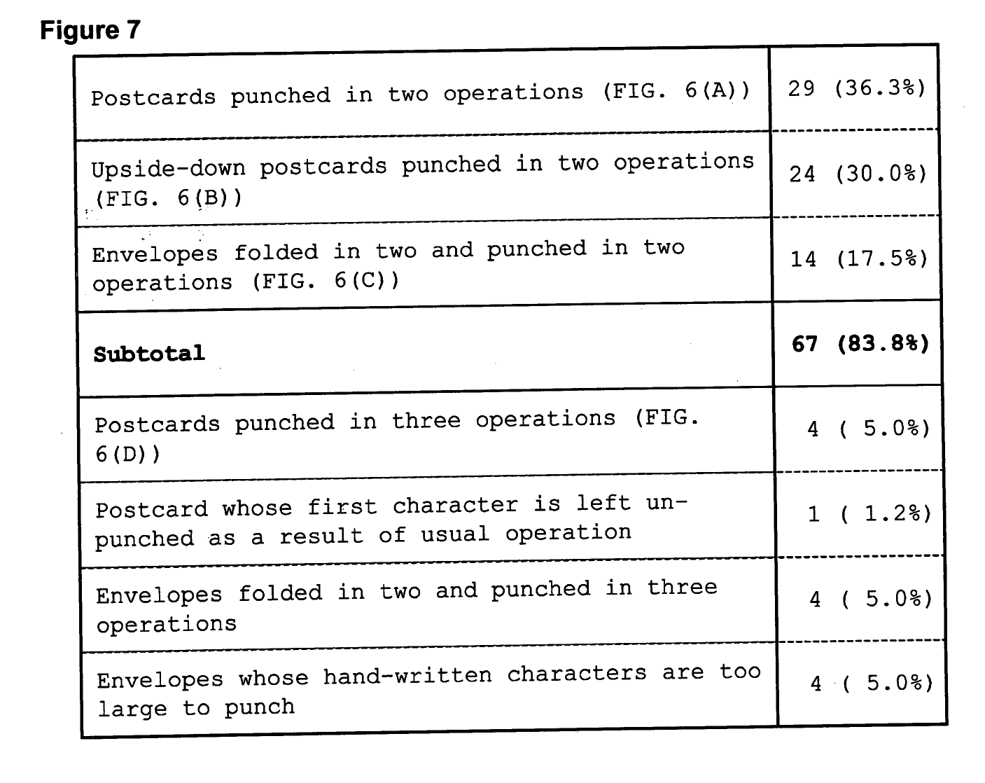

FIG. 7 shows the result of the classification of 80 postcards and envelopes into the cases (A)-(D) shown in FIG. 6. As shown in FIG. 7, most (83.8%) can be punched to such a degree that the information cannot be identified simply by performing two punch operations in which the address and name part identifying a person is shifted from one position to another. Because three operations are required for the address and the name that are written in three rows, this case is virtually equivalent to one operation per one row. Even if one character is left un-punched, it is difficult to identify the information in its entirety and therefore no problem actually arises. Therefore, this embodiment fully applies to addresses other than those hand-written. Considering that hand-written post cards and envelopes are quite few (5.0%) and that the punch operation, if repeated, is still efficient for large hand-written characters, the information outflow prevention punch with the dimension in the first embodiment is sufficiently practical.

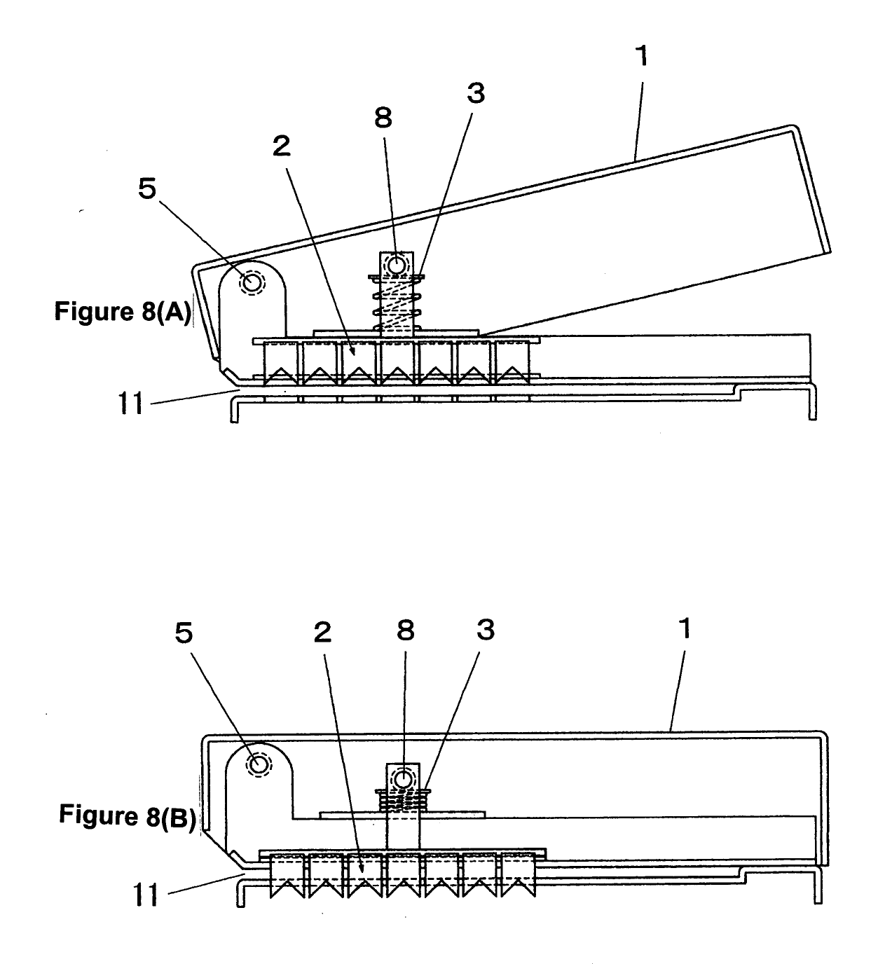

FIG. 8 is a cross section diagram showing a second embodiment of an information outflow prevention punch according to the present invention. The second embodiment differs from the first embodiment in that a lifting spring 3 is a coil spring provided above the punch blade group 2.

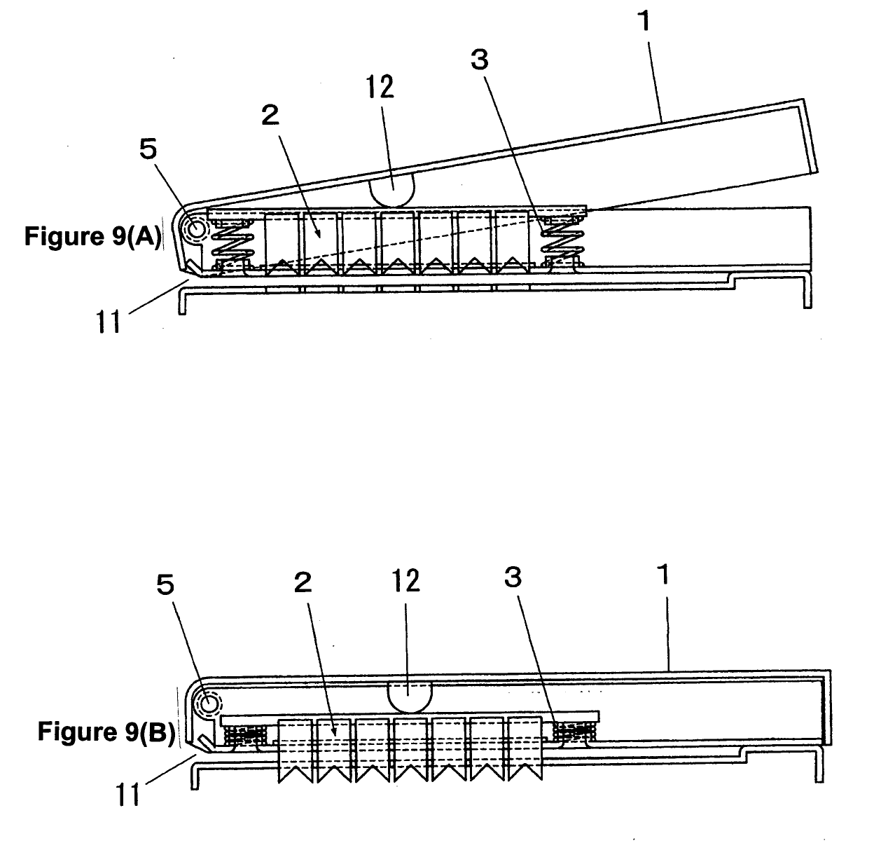

FIG. 9 is a cross section diagram showing a third embodiment of an information outflow prevention punch according to the present invention. The third embodiment differs from the first embodiment in that a lifting spring 3 is a coil spring and that the punch blade group 2 is lowered by a raised part 12.

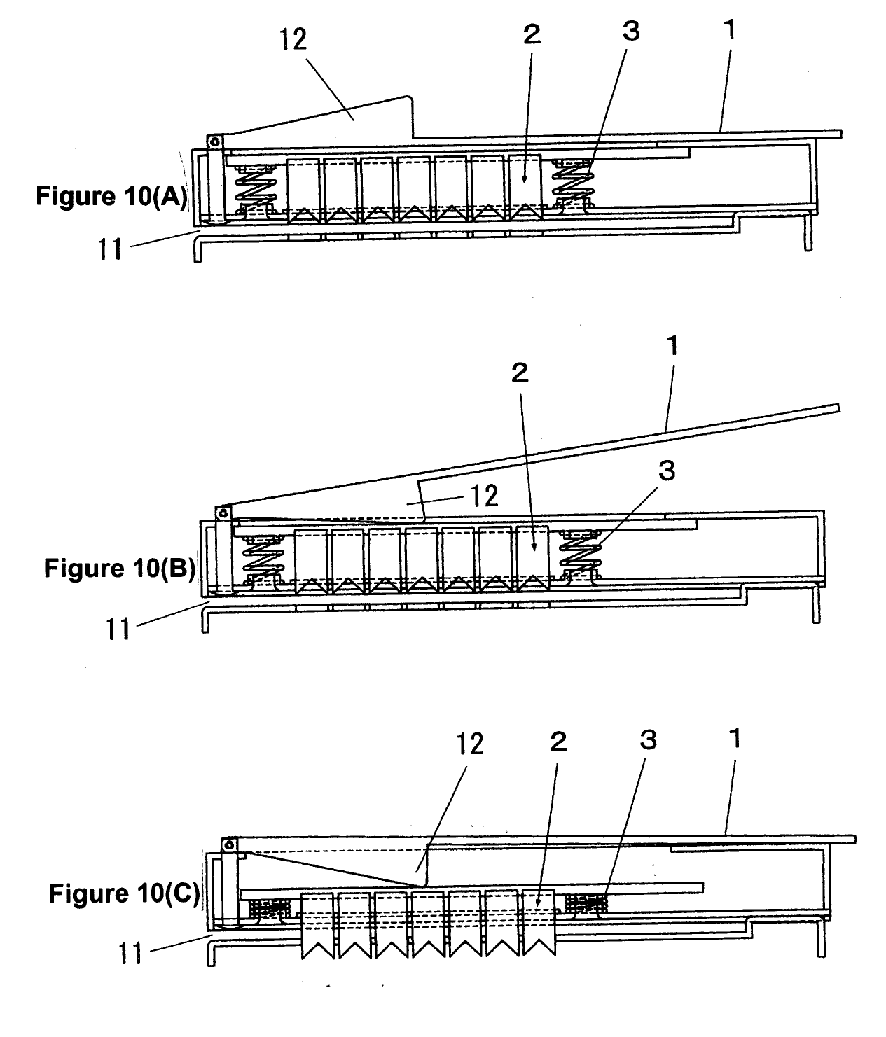

FIG. 10 is a cross section diagram showing a fourth embodiment of an information outflow prevention punch according to the present invention. The third embodiment is a stapler type punch, while the fourth embodiment is a nail clipper type punch. That is, the fourth embodiment is structured so that an operation part 1 that has a raised portion 12 can be reversed. As shown in FIG. 10(A), this structure not only makes the punch compact when not used but also prevents the punch blade group 2 from being lowered unintentionally.

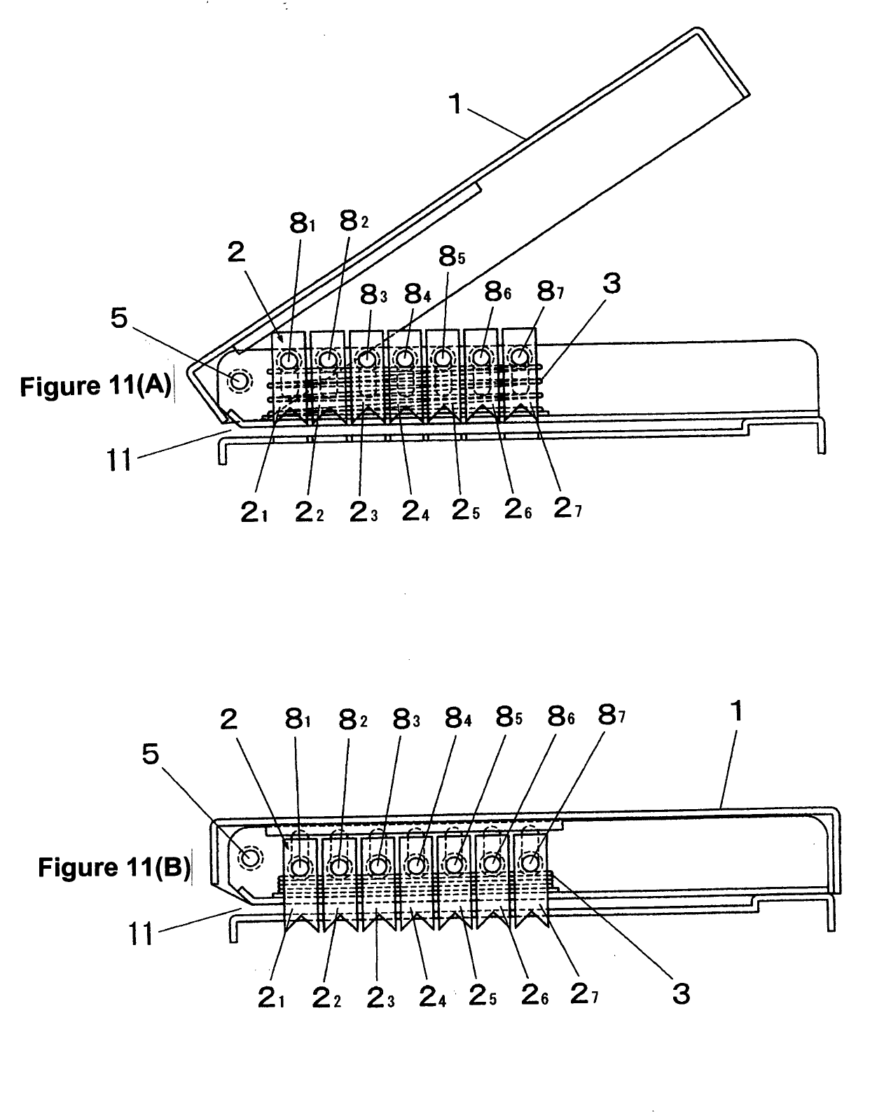

FIG. 11 is a cross section diagram showing a fifth embodiment of an information outflow prevention punch according to the present invention. The fifth embodiment differs from the first embodiment in that support axes 8₁, 8₂, . . . , 8₇ are provided for punch blades 2₁, 2₂, . . . , 2₇ of the punch blade group 2, one for each, and in that a lifting spring 3 (an oval coil spring), which applies force to each of the support axes 8₁, 8₂, . . . , 8₇, is employed so that the punch blades are lowered in order of punch blades 2₁, 2₂, . . . , when an operation part 1 is pushed down.

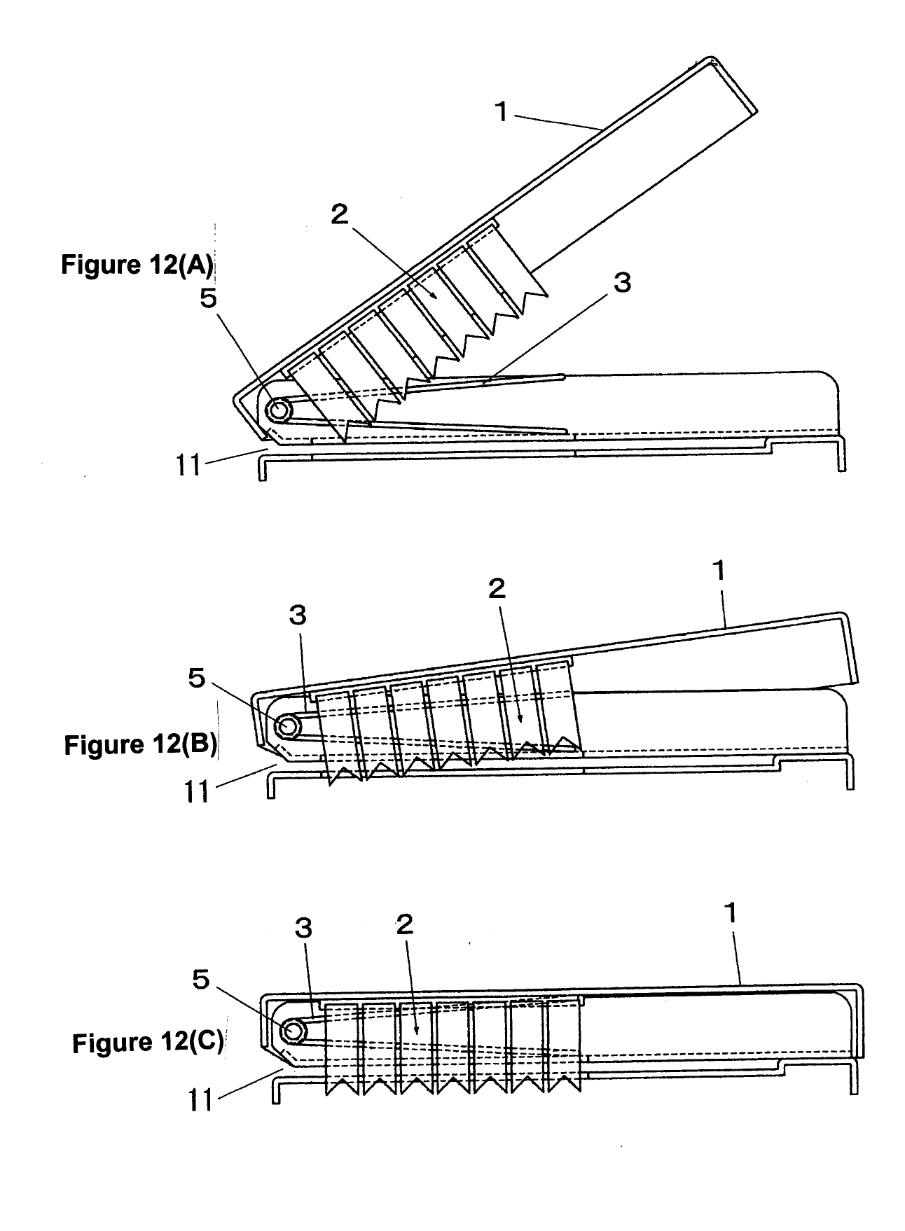

FIG. 12 is a cross section diagram showing a sixth embodiment of an information outflow prevention punch according to the present invention. Unlike the first embodiment in which the blade edges of punch blades 2₁, 2₂, . . . , 2₇ of the punch blade group 2 are lowered parallel to the surface of a punch material, they are lowered in conjunction with an operation part 1 in the sixth embodiment to make the structure simple.

### INDUSTRIAL APPLICABILITY

An information outflow prevention punch according to the present invention comprises an operation part that is longitudinally long; a punch blade group composed of two or more punch blades forming a column in a longitudinal direction in the operation part; a rotation axis running at a right angle to a direction of the column of the punch blades and provided in a front end side of the operation part; a top base supporting the rotation axis in the front end side; and a bottom base fixed to the top base in a rear end side and forming an insertion slot for a punch material in conjunction with the top base, characterized in that the operation part rotates up and down with the rotation axis as a fulcrum, in that neighboring n-th punch blade and (n+1)-th punch blade of the punch blade group are provided close to such a degree that information written on the punch material cannot be identified, and in that a punch material is inserted from the insertion slot at the front edge side of the operation part and the rear end of the operation part is pushed down to lower the punch blade group from above the top base and, thus, the user can easily cut characters such as those of an address and easily protect privacy.

Because the user can readily punch a name part with the punch in his or her hand and use it as if the user was using a paper punch, the user finds it easy to use. Because this punch does not take up space as a shredder does, it can be placed near at hand with little or no psychological burden at use time. In addition, punched postcards and envelopes can be recycled and therefore the consciousness of recycling issues is raised.

1. An information outflow prevention punch comprising an operation part that is longitudinally long; a punch blade group composed of two or more punch blades forming a column in a longitudinal direction in said operation part; a rotation axis running at a right angle to a direction of the column of the punch blades and provided in a front end side of said operation part; a top base supporting said rotation axis in the front end side; and a bottom base fixed to said top base in a rear end side and forming an insertion slot for a punch material in conjunction with said top base, characterized in that the operation part rotates up and down with said rotation axis as a fulcrum, in that neighboring n-th punch blade and (n+1)-th punch blade of said punch blade group are provided close to such a degree that information written on the punch material cannot be identified, and in that a punch material is inserted from the insertion slot at the front edge side of said operation part and the rear end of said operation part is pushed down to lower said punch blade group from above said top base to punch a plurality of holes in the punch material for preventing information outflow.

2. The information outflow prevention punch according to claim 1 characterized in that a diameter of each punch blade of said punch blade group is φ3 mm to φ20 mm and a spacing between the neighboring n-th punch blade and (n+1)-th punch blade of said punch blade group is smaller than a diameter of the n-th punch blade and smaller than a diameter of the (n+1)-th punch blade.

3. The information outflow prevention punch according to claim 1 characterized in that said information outflow prevention punch has a lifting spring for said operation part and said punch blade group.

4. The information outflow prevention punch according to claim 1 characterized in that blade edges of the punch blades of said punch blade group are lowered parallel to a surface of the punch material.

5. The information outflow prevention punch according to claim 1 characterized in that a marking indicating a position of said punch blade group is provided.

6. (canceled)

7. The information outflow prevention punch according to claim 1 characterized in that a chip bin is provided under said punch blade group.

8. The information outflow prevention punch according to claim 1 characterized in that a stopper that holds said operation part in a pushed-state is provided.
